(19) United States
(12) Patent Application Publication
(10) Pub. No.: US 2013/0049248 A1
(43) Pub. Date: Feb. 28, 2013

(54) Method of Producing Artificial Stones with Aluminum residues

(71) Applicants: Sheng-Fu Yang, New Taipei City (TW); Yen-Hua Chang, New Taipei City (TW); Chun-Yen Yeh, New Taipei City (TW); To-Mei Wang, New Taipei City (TW); Wen-Cheng Lee, Taoyuan County (TW); Kin-Seng Sun, Taoyuan County (TW); Chin-Ching Tzeng, New Taipei City (TW)

(72) Inventors: Sheng-Fu Yang, New Taipei City (TW); Yen-Hua Chang, New Taipei City (TW); Chun-Yen Yeh, New Taipei City (TW); To-Mei Wang, New Taipei City (TW); Wen-Cheng Lee, Taoyuan County (TW); Kin-Seng Sun, Taoyuan County (TW); Chin-Ching Tzeng, New Taipei City (TW)

(73) Assignee: ATOMIC ENERGY COUNCIL-INSTITUTE OF NUCLEAR ENERGY RESEARCH, Taoyuan County (TW)

(21) Appl. No.: 13/222,061

(22) Filed: Aug. 31, 2011

(51) Int. Cl. B29C 39/42; B29C 39/10

(52) U.S. Cl. 264/102; 264/279.1

(57) ABSTRACT

The present disclosure uses aluminum residues to fabricate artificial stones. The aluminum residues are obtained from a recycle process of aluminum scrap. The aluminum residues is made into dross and baghouse dust as raw materials for the artificial stones. The artificial stones thus made are improved in characteristics of mechanical strength, hardness, abrasion resistance, flame resistance and anti-oxidation. Hence, the present disclosure reduces impacts to the nature; obtains derived products from recycled aluminum residues; increases commercial income; decreases cost for handling aluminum residues; and saves the use of aluminum oxide, aluminium hydroxide or silicon oxide on making artificial stones. The artificial stones thus made are fit to be used in fields of green material, green construction and green industry.

### TECHNICAL FIELD OF THE DISCLOSURE

The present disclosure relates to produce artificial stones; more particularly, relates to apply aluminum dross and residues (from bag house) obtained from a recycle process of aluminum scrap as raw materials for producing artificial stones under room temperature.

### DESCRIPTION OF THE RELATED ARTS

Recycle process of aluminum scrap uses small reverberatory furnaces with aluminum wastes collected and divided into categories to be made into aluminum ingots. Secondary materials of aluminum scrap include new wastes and old wastes. New wastes include aluminum tailing, aluminum residues and unqualified aluminum products, where about 70% of recycled aluminum comes from. Old wastes include used aluminum products, like aluminum wires and cores, aluminum components and castings of car bodies, aluminum cans and aluminum household appliances.

The recycle process of aluminum scrap does not pollute the environment very much and its byproduct is mainly aluminum residues. The aluminum residues includes dross and baghouse dust. In the recycle process, including melting aluminum scrap, recycling aluminum liquid, cooling down temperature, etc., gases having suspended particulates may be produced. These particulates can be collected with air pollution control utilities, like baghouse collector. The collected particulates are called white dust (Murayama, N., Shibata, J., Sakai, K., Nakajima, S, and Yamamoto, H., “Synthesis of hydrotalcite-like materials from various wastes in aluminum regeneration process”, Resource Processing 53, pp. 6-11, 2006), or baghouse dust. The amount of baghouse dust may be 1 wt % of the original aluminum scrap recycled and the main components of the baghouse dust are Al₂O₃, MgO and carbon (which mainly comes from the fuel used in the recycle process). Besides, aluminum dross is also produced, which floats on aluminum liquid and are mainly composed of aluminum metal, aluminum oxides and aluminum nitrides and its amount is about 15 wt % of the original aluminum scrap. The byproducts of aluminum residues, no matter dross or baghouse dust, will be hydrolyzed in the air owing to the aluminum nitrides contained. They absorb moist to produce ammonia, which bursts into odd gas. For casting or burying, the aluminum residues has to be neutralized and solidified. (Hermsmeyer, D., Diekmann, R., Ploeg R. R. and Horton R., “Physical properties of a soil substitute derived from an aluminum recycling by-product”, Journal of Hazardous Materials B95, pp. 107-124, 2002; Shinzato, M. C. and Hypolito, R., “Solid waste from aluminum recycle process: characterization and reuse of its economically valuable constituents”, Waste Management 25, pp. 37-46, 2005; and, Murayama, N., Arimura, K., Okajima, N. and Shibata, J., “Effect of structure-directing agent on AIPO4-n synthesis from aluminum dross”, International Journal of Mineral Processing 93, pp. 110-114, 2009)

If the dross and baghouse dust of aluminum residues are handled by landfill only, impacts on the environment may not be avoided and may cause harm to human health. Yet, aluminum residues still have economic value, no matter for its physical characteristics or its amount. A prior art uses aluminum wastes of water quenching slag as raw materials to be made into water quenching slag artificial stones having high added value. Yet, the whole procedure to produce water quenched slag is operated under a high temperature with expensive utilities and consumes enormous energy, not to mention the time for powering up the utilities or shooting them down is long.

Other prior arts for making artificial stone with aluminum residues all use additional natural materials, like stone dusts, aluminum oxides, non-organic particles, powders of granite or marble, etc. Yet, for obtaining a great amount of these additional natural materials, the nature may be seriously harmed with a lot of carbon dioxide emitted on using utilities.

Hence, the prior arts do not fulfill all users' requests on actual use.

### SUMMARY OF THE DISCLOSURE

The main purpose of the present disclosure is to use dross and baghouse dust of aluminum residues obtained from a recycle process of aluminum scrap as raw materials for producing artificial stones under room temperature.

The second purpose of the present disclosure is to use dross and baghouse dust of non-organic aluminum oxide and silicon oxide for improving flame resistance and anti-oxidation of artificial stones.

The third purpose of the present disclosure is to use a cost-saved recycled material in fields of green material, green construction, green industry and green reusing for recycling wastes and decreasing impacts of the wastes to the nature.

The fourth purpose of the present disclosure is to recycle dross and baghouse dust of aluminum residues for reducing or placing materials used on producing artificial stones.

To achieve to the above purposes, the present disclosure is a method of producing artificial stones with aluminum residues, comprising steps of: (a) obtaining a secondary material of aluminum residues from a recycle process of aluminum scrap; (b) stirring the aluminum residues with a resin, a hardening agent, a defoaming agent and a promoting agent added simultaneously to form a slurry mixture, where the resin has an adding amount ratio between 42.5˜64.0 wt %; (c) putting the slurry mixture into a mold to be crosslinked and hardened under a room temperature to obtain an object body; and (d) releasing the mold to form an artificial stone composite material. Accordingly, a novel method of producing artificial stones with aluminum residues is obtained.

### BRIEF DESCRIPTIONS OF THE DRAWINGS

The present disclosure will be better understood from the following detailed description of the preferred embodiment according to the present disclosure, taken in conjunction with the accompanying drawings, in which

FIG. 1 is the ingredient view showing the preferred embodiment according to the present disclosure;

FIG. 2 is the flow view showing the preferred embodiment;

FIG. 3 is the view showing the relationship between the adding amount of the aluminum residues and the viscosity of the slurry mixture;

FIG. 4 is the view showing the relationship between the adding amount of the aluminum residues and the density of the artificial stone;

FIG. 5 is the view showing the relationship between the adding amount of the defoaming agent and the density of the artificial stone;

FIG. 6 is the view showing the relationship between the adding amount of the aluminum residues and the absorption ratio of the artificial stone;

FIG. 7 is the view showing the relationship between the adding amount of the defoaming agent and the water absorption ratio of the artificial stone;

FIG. 8 is the view showing the relationship between the adding amount of the aluminum residues and the water content of the artificial stone;

FIG. 9 is the view showing the relationship between the adding amount of the defoaming agent and the water content of the artificial stone;

FIG. 10 is the view showing the relationship between the adding amount of the aluminum residues and the outside-surface barcol hardness of the artificial stone;

FIG. 11 is the view showing the relationship between the adding amount of the aluminum residues and the sectional-surface barcol hardness of the artificial stone;

FIG. 12 is the view showing the relationship between the adding amount of the defoaming agent and the outside-surface barcol hardness of the artificial stone;

FIG. 13 is the view showing the relationship between the adding amount of the defoaming agent and the sectional-surface barcol hardness of the artificial stone;

FIG. 14 is the view showing the relationship between the adding amount of the aluminum residues and the compressive strength of the artificial stone;

FIG. 15 is the view showing the relationship between the adding amount of the defoaming agent and the compressive strength of the artificial stone;

FIG. 16 is the view showing the compressive strength of the defoaming-agent-added artificial stone obtained after the vacuum degassing;

FIG. 17 is the view showing the relationship between the adding amount of the aluminum residues and the flexural strength of the artificial stone;

FIG. 18 is the view showing the relationship between the adding amount of the defoaming agent and the flexural strength of the artificial stone; and

FIG. 19 is the view showing the toxicity and the pH value of the artificial stone.

### DESCRIPTION OF THE PREFERRED EMBODIMENT

The following description of the preferred embodiment is provided to understand the features and the structures of the present disclosure.

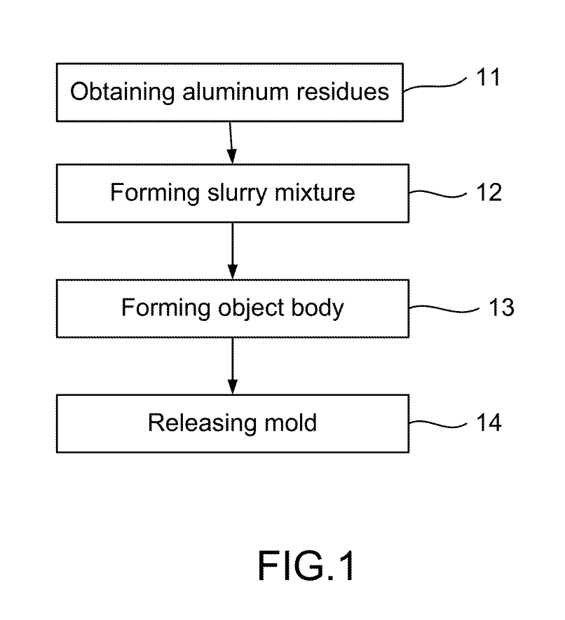

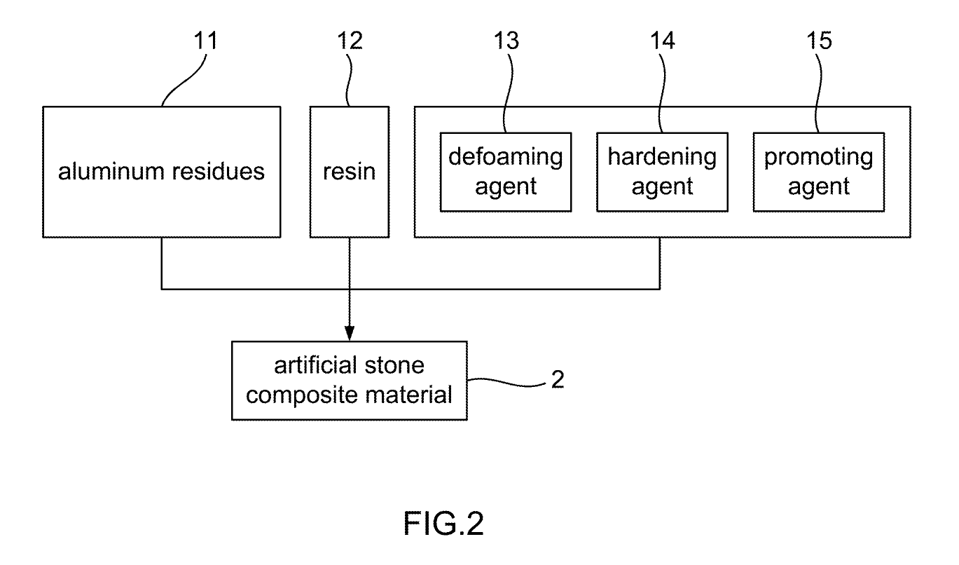

Please refer to FIG. 1 and FIG. 2, which are a flow view and an ingredient view showing a preferred embodiment according to the present disclosure. As shown in the figures, the present disclosure is a method of producing artificial stones with aluminum residues, comprising the following steps:

(a) Obtaining aluminum residues 11: A secondary material of aluminum residues 21 is obtained from a recycling process of aluminum scrap.

(b) Forming slurry mixture 12: The aluminum residues is stirred with a resin 22, a defoaming agent 23, a hardening agent 24 and a promoting agent 25 added simultaneously for obtaining a slurry mixture, where the resin 22 has an adding amount ratio between 42.5˜64.0 wt %.

(c) Forming object body 13: The slurry mixture is poured into a mold to be crosslinked and hardened under a room temperature to form an object body.

(d) Releasing mold 14: In the end, the mold is released to obtain an artificial stone composite material 2 of aluminum residues.

Thus, a novel method of producing artificial stones with aluminum residues is obtained, where a waste of aluminum residues is used as a resource to be recycled for producing an artificial stone composite material having a high added value.

On using the present disclosure, an amount of aluminum scrap is collected. An aluminum residues 21 is obtained from a secondary material of the aluminum scrap through a recycling process. The aluminum residues 21 comprises dross and baghouse dust. The dross is crushed and then big pellets in the crushed dross are filtered out to be recycled through a furnace. Small pellets left after filtering out the big pellets are further smashed, grinded and filtered to be added with the baghouse dust to form powder of dross/baghouse dust having uniform granular size. The powder of dross/baghouse dust is dried to be stored. The powder of dross/baghouse dust is then taken out and is added with 33.3˜61.5 wt % of a resin 22 and 0˜3.5 wt % of a defoaming agent 23 according a mix proportion design. Then, 1˜5 wt % of a hardening agent 24 and a promoting agent 25 are added to be stirred for obtaining a slurry mixture. The slurry mixture is poured into a mold to be stayed under a room temperature for hardening. After the mold is released, the hardened slurry mixture is processed through cutting, edge-preparing, stacking and polishing. Thus, an artificial stone composite material 2 of aluminum residues is obtained, where the artificial stone composite material 2 can be an artificial stone of thermosetting resin made into a material of a decoration board, a casting sheet, a laminated plate or a movable partition wall.

Therein, 1˜20 minutes of a vacuum degassing process can be used to further remove bubbles in the slurry mixture. The secondary material is an old aluminum scrap of aluminum wires; components and castings of car body; aluminum cans; and/or aluminum household appliances. The artificial stone composite material 2 is an object body composed of the aluminum residues 21, the resin 22, the defoaming agent 23, the hardening agent 24 and the promoting agent 25. The aluminum scrap for making the secondary material can be old or wasting materials of aluminum wires; components and castings of car body; aluminum cans; and/or aluminum household appliances. The resin 22 can be an unsaturated polyester resin having a specific gravity between 1.11 g/cm³ and 1.13 g/cm³. The hardening agent 24 can be methyl ethyl ketone peroxide (MEKPO), which can be hardened under a room temperature. The promoting agent 25 can be cobalt octoate having 6% of cobalt, which is a purple red liquid for promoting polymerization.

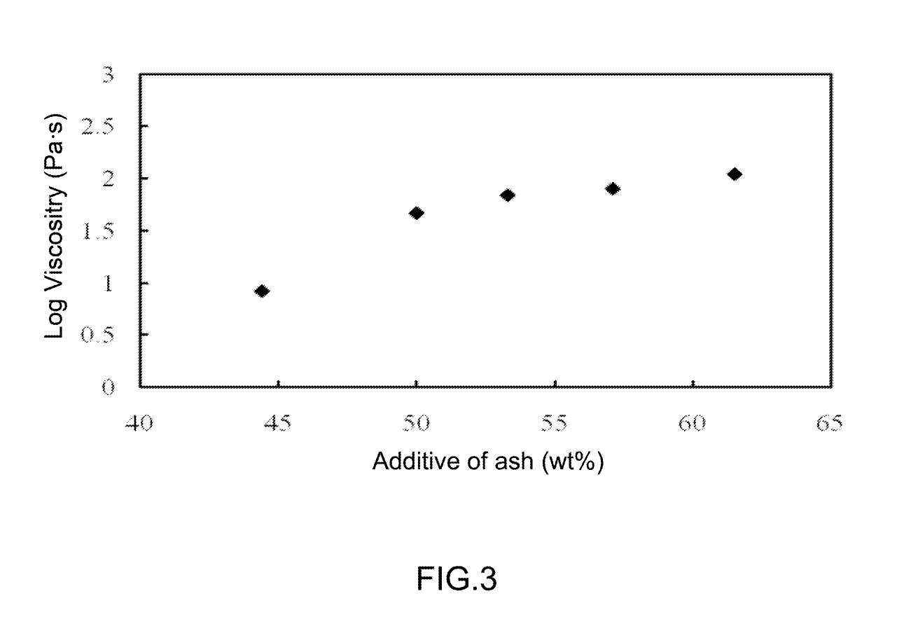

Please refer to FIG. 3, which is a view showing relationship between adding amount of aluminum residues and viscosity of a slurry mixture. As shown in the figure, for obtaining a good slurry flow in the fabrication process and forming a good object body in a mold and recycling a good amount of aluminum residues, more solid component with lower viscosity is preferred to be used on producing a slurry mixture. Under a good distribution characteristic, the viscosity of the slurry mixture increases when more solid components are added. When the adding amount of the aluminum residues increases from 44.4 wt % to 53.3 wt %, the viscosity increases very fast. When the adding amount of the aluminum residues increases from 53.3 wt % to 61.5 wt %, the viscosity increases slow. When the adding amount of the aluminum residues increases over 61.5 wt %, the viscosity becomes too high to be used for fabrication. Hence, a preferred adding amount ratio of the aluminum residues is 44.4 wt %˜61.5 wt %.

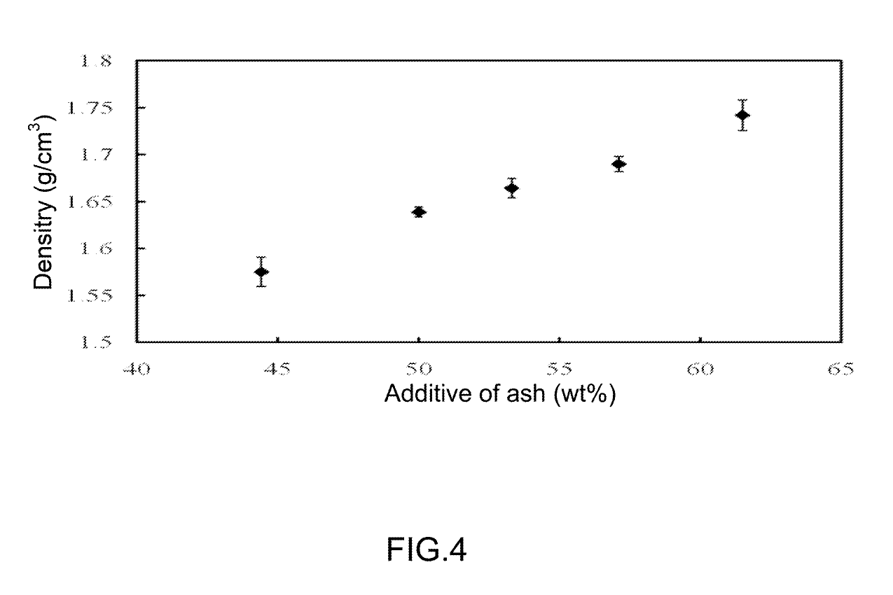

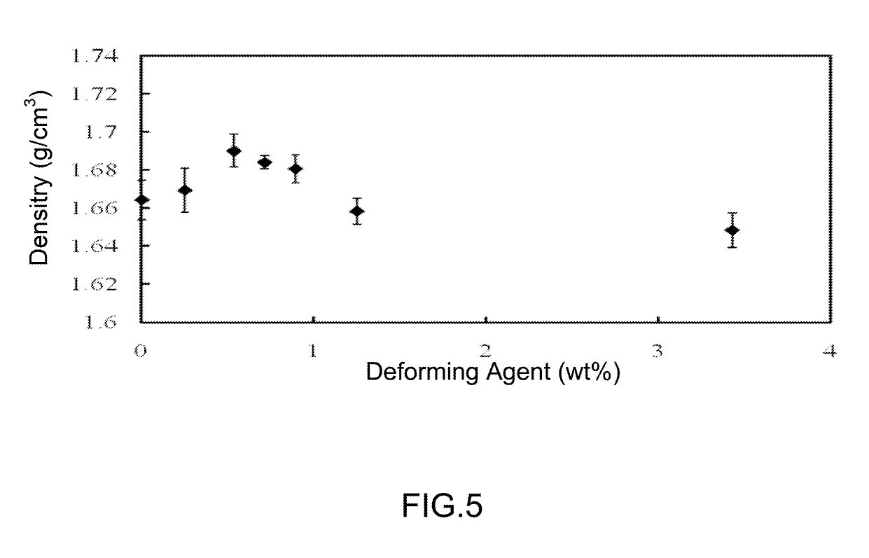

Please refer to FIG. 4 and FIG. 5, which are views showing relationship between adding amount of aluminum residues and density of an artificial stone and relationship between adding amount of defoaming agent and density of the artificial stone. As shown in the figures, an artificial stone composite material of aluminum residues is cut into a size of 50(L)×20(W)×20(T) mm. In FIG. 4, mass of the artificial stone per cubic unit is increased following the growth of adding amount of the aluminum residues. When the adding amount ratio of the aluminum residues is between 44.4 wt % and 61.5 wt %, density of the artificial stone is between 1.58 g/cm³ and 1.74 g/cm³.

For increasing the density of the artificial stone, a defoaming agent can be added to increase slurry viscosity and to further decrease number of bubbles. In FIG. 5, when the adding amount of the defoaming agent increases, the density of the artificial stone increases as well. When the adding amount ratio of the defoaming agent is 0˜0.54 wt %, the density of the artificial stone is 1.66˜1.69 g/cm³. But, when the adding amount ratio of the defoaming agent is bigger than 0.54 wt %, the density of the artificial stone reduces for that viscosity of the slurry becomes too small and bubbles is increased. Hence, a preferred adding amount ratio of the defoaming agent is 0.54 wt % for obtaining an artificial stone having a preferred viscosity.

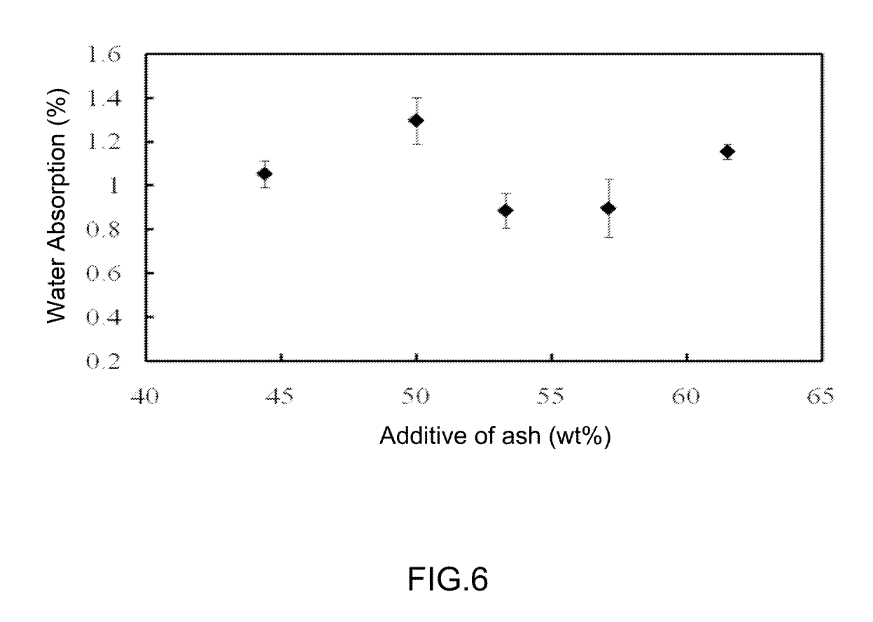

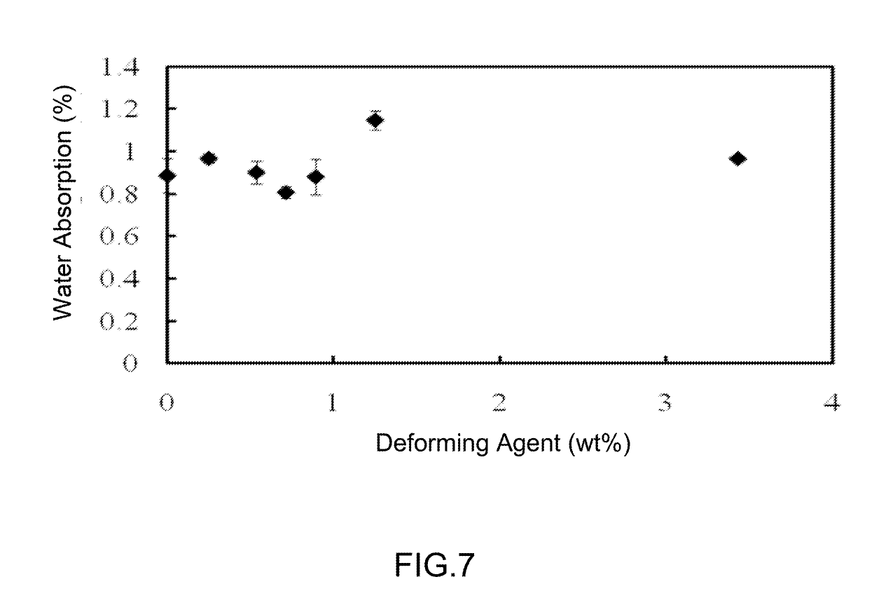

Please refer to FIG. 6 and FIG. 7, which are a view showing relationship between adding amount of aluminum residues and absorption ratio of artificial stone; and a view showing relationship between adding amount of defoaming agent and absorption ratio of the artificial stone. As shown in the figures, an artificial stone composite material of aluminum residues is cut into a size of 75(L)×25(W)×3(T) mm. to be dried in an oven at 50° C. for 24 hours and then sunk in a de-ionized water for 24 hours for obtaining absorption ratio of the artificial stone according to changes of weight of the artificial stone. In FIG. 6 and FIG. 7, adding amounts of aluminum residues and defoaming agent do not show linear relationships to the absorption ratio of the artificial stone. When the adding amount ratio of aluminum residues is 44.4˜61.5 wt % and the adding amount ratio of defoaming agent is 0˜3.43 wt %, the absorption ratios of the artificial stone are 0.8˜1.3% and 0.8˜1.1%, respectively. A material having a small absorption ratio is not easily cracked or stripped off from a building or weakened in mechanical strength owing to water-seeping or heat-expansion-and-cold-contraction. Thus, the present invention can be used fabricate an artificial stone having a small absorption ratio.

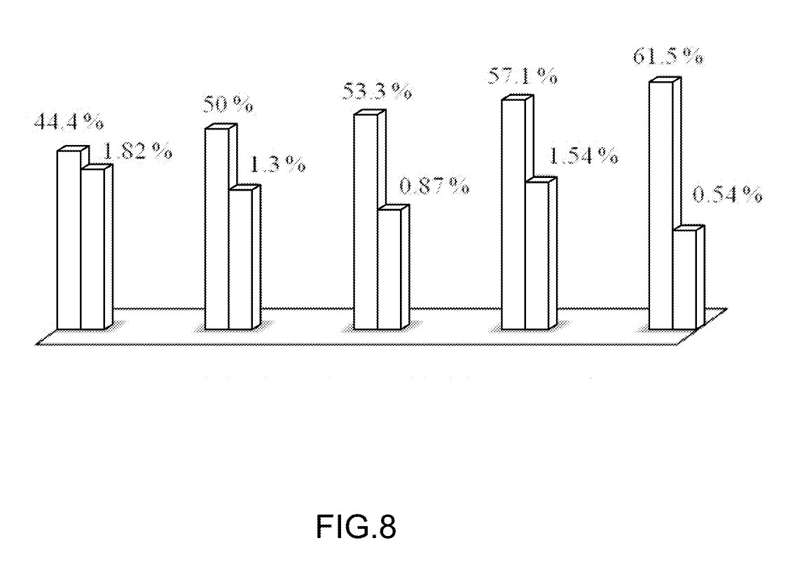

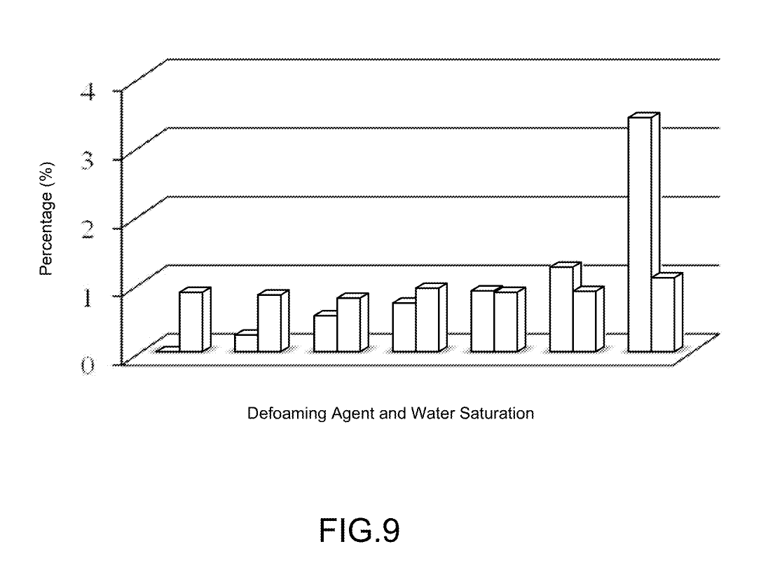

Please refer to FIG. 8 and FIG. 9, which are a view showing relationship between adding amount of aluminum residues and water content of an artificial stone; and a view showing relationship between adding amount of defoaming agent and water content of the artificial stone. As shown in the figures, an artificial stone composite material of aluminum residues is cut into a size of 75(L)×25(W)×3(T) mm. After being put into a room-temperature environment for 3 days, the artificial stone is hot-fried for measuring water content of the artificial stone according to changes of weight of the artificial stone. In FIG. 8 and FIG. 9, adding amounts of aluminum residues and defoaming agent do not show linear relationships to water content of the artificial stone. When the adding amount ratio of aluminum residues is 44.4˜61.5 wt % and the adding amount ratio of defoaming agent is 0˜3.43 wt %, the water contents of the artificial stone are 0.5˜1.8% and 0.8˜1.1%, respectively. A material having a small water content is not easily cracked or stripped off from a building or weakened in mechanical strength owing to water-seeping or heat-expansion-and-cold-contraction. Thus, the present invention can be used to fabricate an artificial stone having a small water content.

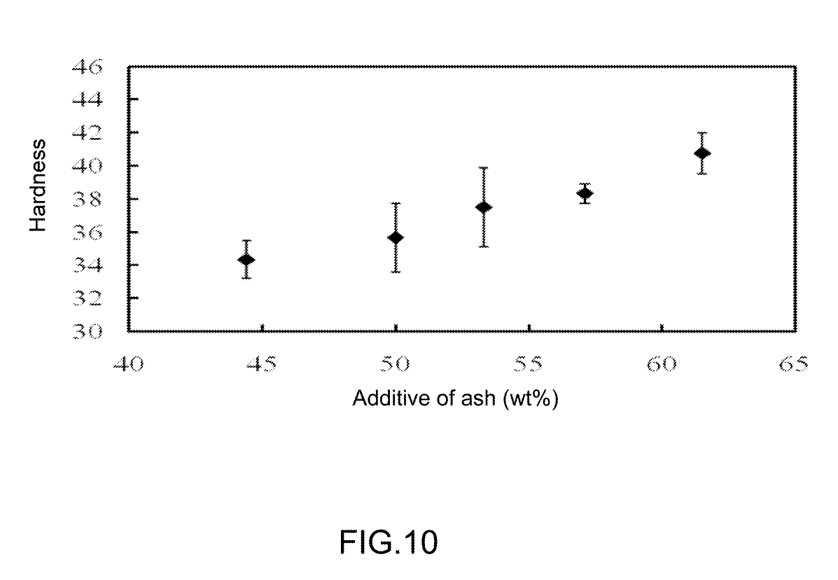

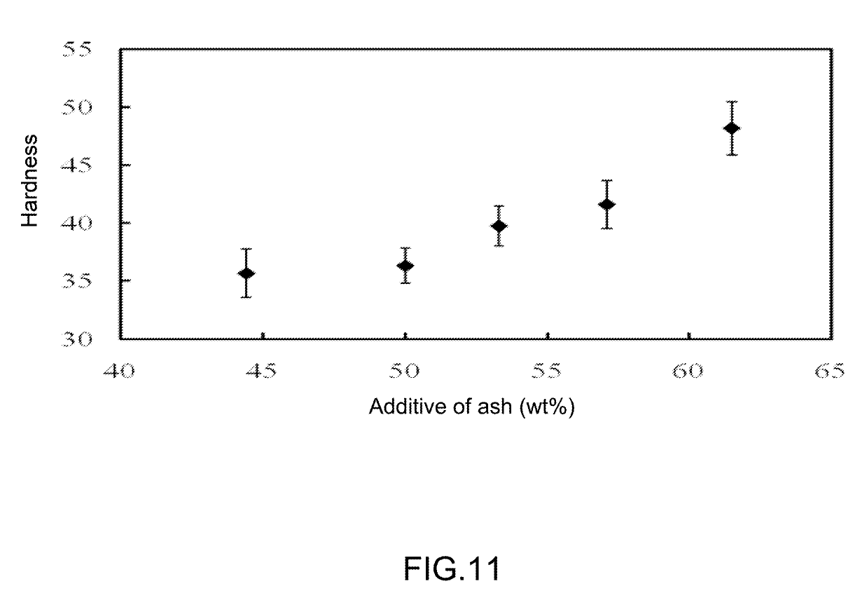

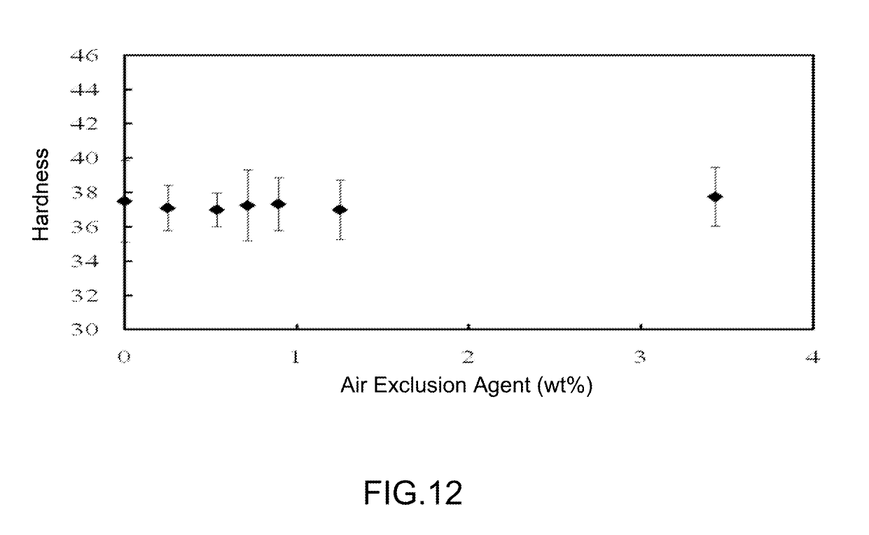

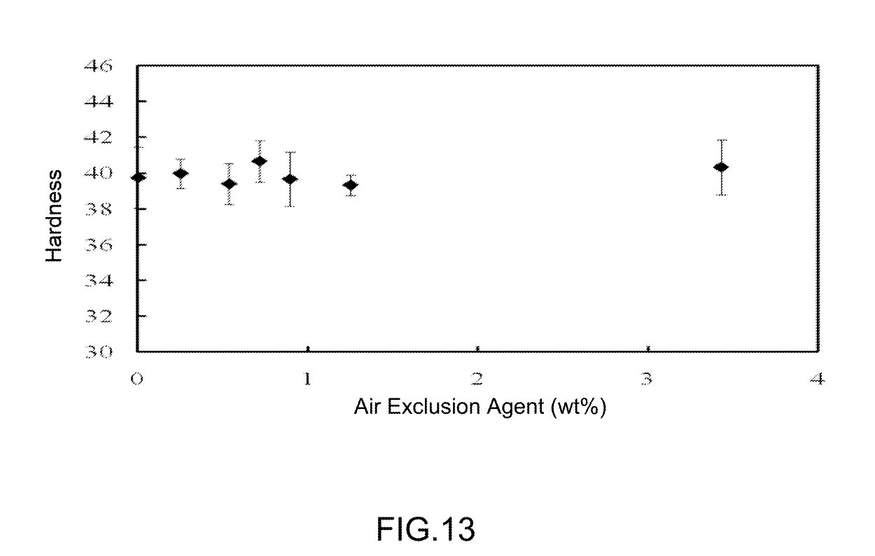

Please refer to FIG. 10 to FIG. 13, which are views showing relationships between adding amount of aluminum residues and outside-surface barcol hardness of an artificial stone, between adding amount of aluminum residues and sectional-surface barcol hardness of the artificial stone, between adding amount of defoaming agent and outside-surface barcol hardness of the artificial stone and between adding amount of defoaming agent and sectional-surface barcol hardness of the artificial stone. As shown in the figures, a disk of an artificial stone composite material of aluminum residues is cut into a size of 50.8(D)×3.2(H) mm with a barcol hardometer used for testing hardness of the artificial stone. In FIG. 10, hardness of the artificial stone is increased when adding amount of aluminum residues is increased. When the adding amount ratio of aluminum residues is increased over 50 wt %, the surface hardness of the artificial stone has a bigger increase. When the adding amount of aluminum residues is increased to 61.5 wt %, the average hardness of the artificial stone is 40.75, which obviously aids in the surface hardness of the artificial stone as comparing to the surface hardness of the artificial stone added with aluminum residues of unsaturated polyester resin (whose value of the surface hardness is 35). In FIG. 11, the increase amount of sectional hardness of the artificial stone is coincided with the increase amount of surface hardness of the artificial stone, except that, with the same adding amount of aluminum residues, the sectional hardness of the artificial stone is bigger than the surface hardness of the artificial stone owing to increase in solid content in a physical unit on the sectional surface.

In the other hand, the adding amount of the defoaming agent does not affect the hardness of the artificial stone, except the mechanical strength of the artificial stone. When the adding amount ratio of the aluminum residues is 53.3 wt % and the adding amount ratio of the defoaming agent is 0.54 wt %, the surface hardness of the artificial stone is 37.

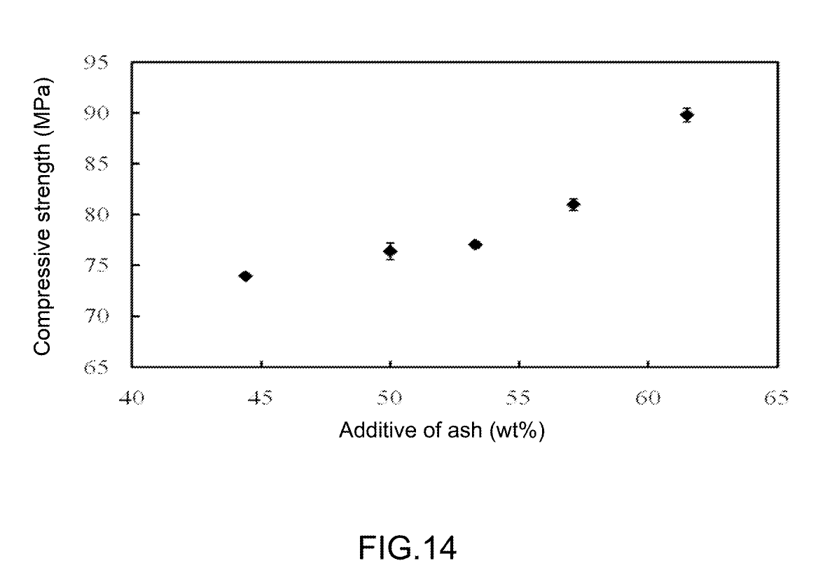

Please refer to FIG. 14 to FIG. 16, which are views showing relationships between adding amount of aluminum residues and compressive strength of an artificial stone and between adding amount of a defoaming agent and compressive strength of the artificial stone; and a view showing compressive strength of the defoaming-agent-added artificial stone obtained after a vacuum degassing. As shown in the figures, artificial stone disks cut into a size of 5(D)×10(H) cm are obtained. In FIG. 14, when adding amount of aluminum residues is increased, compressive strength of the artificial stone is increased too. When the adding amount ratio of aluminum residues is 44˜62 wt %, the compressive strength is 74˜90 MPa. Hence, the pellets of dross and baghouse dust are added into the artificial stone to improve the mechanical strength of the artificial stone.

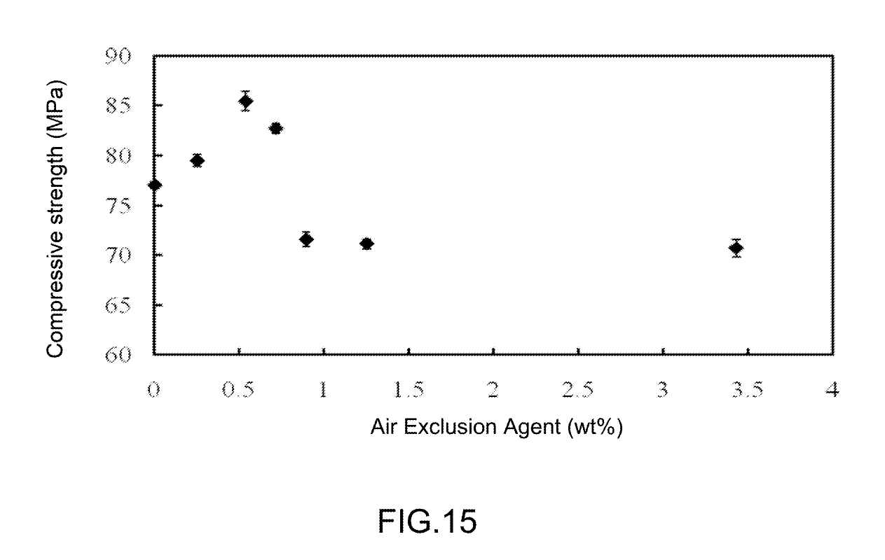

In FIG. 15, by adding of the defoaming agent, density of the artificial stone is enhanced. The compressive strength is enhanced as well. When the adding amount ratio of the defoaming agent is 0˜0.54 wt %, the compressive strength of the artificial stone is increased to 77˜85 MPa. But, when the adding amount ratio of the defoaming agent is bigger than 0.54 wt %, the compressive strength of the artificial stone is decreased to 71 MPa.

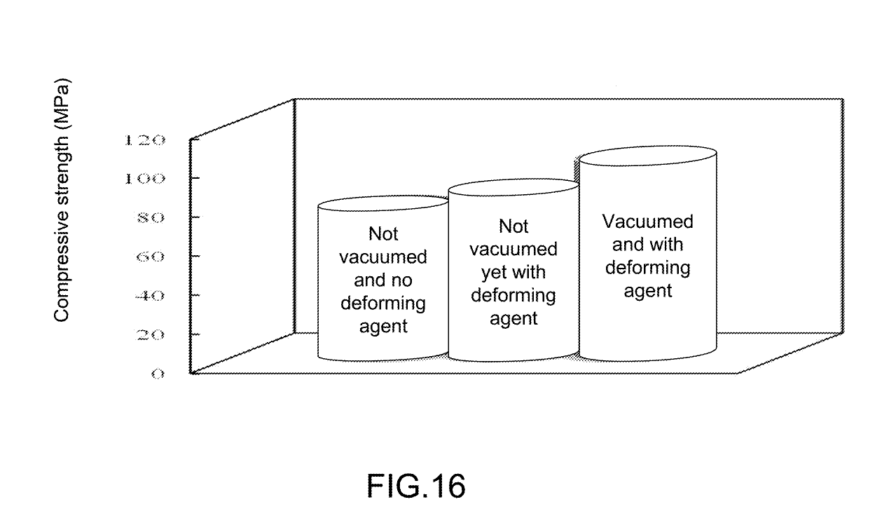

In FIG. 16, by adding the defoaming agent coordinated with a vacuum degassing machine, outside and sectional surfaces of the artificial stone are so dense that almost no pores are found and the compressive strength of the artificial stone is also improved to about 101 MPa.

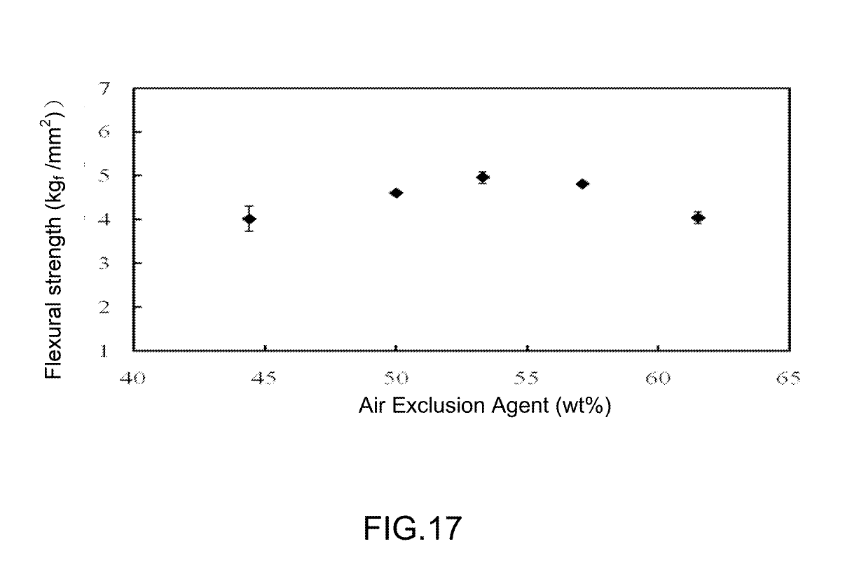

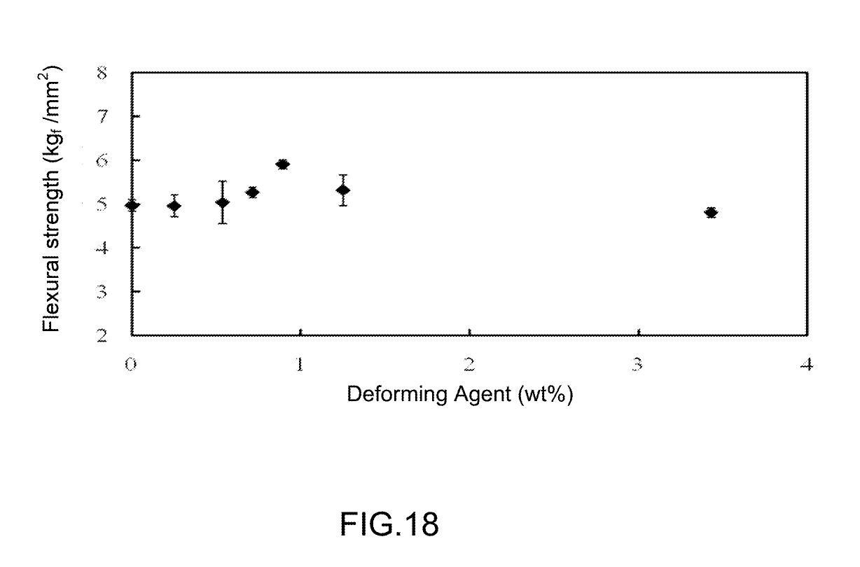

Please refer to FIG. 17 and FIG. 18, which are a view showing relationship between adding amount of aluminum residues and flexural strength of an artificial stone; and a view showing relationship between adding amount of defoaming agent and the flexural strength of the artificial stone. As shown in the figures, artificial stones cut into a size of 150(L)×38(W)×9(T) mm are obtained. In FIG. 17, when adding amount of aluminum residues is increased, flexural strength of an artificial stone is increased too. When the adding amount ratio of aluminum residues is 44˜53 wt %, the flexural strength is 4˜5 kgf/mm². But, when the adding amount ratio of aluminum residues is bigger than 53 wt %, the flexural strength is decreased. When the adding amount ratios of aluminum residues are 57 wt % and 62 wt %, the flexural strengths are 4.8 kgf/mm² and 4 kgf/mm². Hence, the artificial stone having an adding amount ratio of aluminum residues smaller than 53 wt % has a high elastic modulus and a high stress for enhancing the flexural strength of the artificial stone.

In FIG. 18, defoaming agent is added to improve density of the artificial stone, as well as to enhance the flexural strength of the artificial stone. When the adding amount ratio of the defoaming agent is 0˜0.89 wt %, the flexural strength of the artificial stone is 4.9˜5.9 kgf/mm², where the flexural strength of the artificial stone is increased as the adding amount ratio of the defoaming agent is increased. But, when the adding amount ratio of the defoaming agent is bigger than 0.89 wt %, the flexural strength of the artificial stone starts to decrease. The flexural strength can be decreased to 4.8 kgf/mm². As a result, 0.54 wt % adding amount ratio of defoaming agent is the best choice in the view of flexural strength, compressive strength and cost.

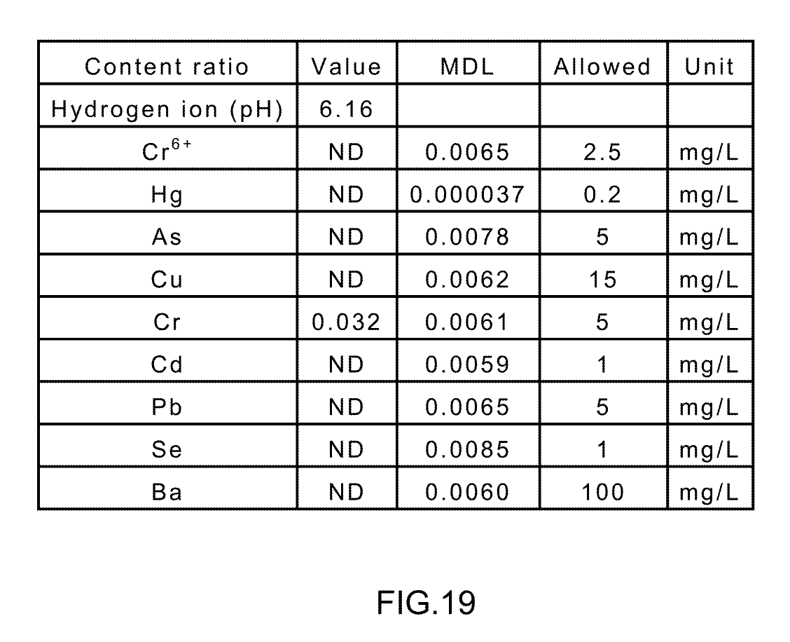

Please refer to FIG. 19, which is a view showing toxicity and pH value of an artificial stone. As shown in the figure, content ratios of selenium (Se), mercury (Hg), lead (Pb), cadmium (Cd), total chromium (Cr), hexavalent chromium (Cr⁶⁺), barium (Ba) and arsenic (As) as well as pH value of the artificial stone are measured. The content ratios of the toxic elements are all below allowed values and the pH value is 6.16. Therein, ‘ND’ means ‘not detected’ under method detection limits (MDL); the content ratio of Cr⁶⁺ is obtained after being diluted 10 times; and the content ratio of hydrogen ion (pH value) is obtained from a liquid used for measuring the toxic elements accordingly. Thus, the artificial stone can be used as a replacement of natural stone powder for reducing consumption of natural resources and avoiding impacts to the nature.

Conclusively, for obtaining good viscosity and usability, a preferred adding amount ratio of aluminum residues for the artificial stone fabricated according to the present disclosure is 53.3 wt % to obtain a density of 1.68 g/cm³ and a water absorption ratio of 0.89%. The artificial stone thus fabricated has an average barcol hardness of 37, a compressive strength of 101 MPa and a flexural strength of 5 kgf/mm². The artificial stone can be made of thermosetting resin to be made into a decoration board, a casting sheet, a laminated plate or a movable partition wall.

Side effects of the artificial stone using aluminum residues includes: (a) reducing impacts to the nature out of burying aluminum residues; (b) obtaining derived products from recycled aluminum residues; (c) increasing commercial income; (d) decreasing cost for handling aluminum residues; and (e) saving the use of aluminum oxide, aluminium hydroxide or silicon oxide on making artificial stones.

Hence, the present disclosure uses aluminum scrap as raw material for recycling. Wastes of dross and baghouse dust of aluminum residues obtained from the recycle process of aluminum scrap are made into artificial stones. The dross and baghouse dust improve mechanical strength, hardness and abrasion resistance of the artificial stones. In addition, the dross and baghouse dust are mainly made of non-organic aluminum oxide and silicon oxide, which have good resistance to heat and flame to enhance flame resistance and anti-oxidation of the artificial stones. Accordingly, the artificial stones fabricated according to the present disclosure are fit for green material, green construction, green industry and green reusing.

To sum up, the present disclosure is a method of producing artificial stones with aluminum residues, where aluminum residues is used to fabricate value-added composite materials for increase commercial income, reducing cost on burying wastes and avoiding impacts to the nature.

The preferred embodiment herein disclosed is not intended to unnecessarily limit the scope of the disclosure. Therefore, simple modifications or variations belonging to the equivalent of the scope of the claims and the instructions disclosed herein for a patent are all within the scope of the present disclosure.

What is claimed is:

1. A method of producing artificial stones with aluminum residues, comprising steps of:
(a) obtaining a secondary material of aluminum residues from a recycling process of aluminum scrap;
(b) stirring said aluminum residues with a resin, a hardening agent, a defoaming agent and a promoting agent added simultaneously to obtain a slurry mixture, wherein said resin has an adding amount ratio between 42.5˜64.0 wt %;
(c) putting said slurry mixture into a mold to be crosslinked and hardened under a room temperature to obtain an object body; and
(d) releasing said mold to obtain an artificial stone composite material.

2. The method according to claim 1,
wherein said secondary material is composed of materials selected from a group consisting of aluminum wires;
components and castings of car body; aluminum cans;
and aluminum household appliances.

3. The method according to claim 1,
wherein said aluminum residues has a preferred adding amount ratio between 44.4˜61.5 wt %.

4. The method according to claim 1,
wherein said resin is an unsaturated polyester resin having a specific gravity between 1.11 g/cm³ and 1.13 g/cm³.

5. The method according to claim 1,
wherein said resin has an adding amount ratio between 33.3˜61.5 wt %.

6. The method according to claim 1,
wherein said defoaming agent has an adding amount ratio between 0˜3.5 wt %.

7. The method according to claim 1,
wherein said hardening agent is methyl ethyl ketone peroxide (MEKPO).

8. The method according to claim 1,
wherein said hardening agent has an adding amount ratio between 1˜5 wt %.

9. The method according to claim 1,
wherein said promoting agent is cobalt octoate having 6% of cobalt.

10. The method according to claim 1,
wherein said promoting agent has an adding amount ratio between 1˜5 wt %.

11. The method according to claim 1,
wherein said method further uses a vacuum degassing process to remove bubbles in said slurry mixture.

12. The method according to claim 11,
wherein said vacuum degassing process is processed for a time period between 1 and 20 minutes.

13. The method according to claim 1,
wherein said artificial stone composite material is an artificial stone of thermosetting resin made into a material selected from a group consisting of a decoration board, a casting sheet, a laminated plate and a movable partition wall.
